(19) United States
(12) Patent Application Publication
(10) Pub. No.: US 2012/0033146 A1
(43) Pub. Date: Feb. 9, 2012

(54) LIQUID CRYSTAL DISPLAY DEVICE AND ELECTRONIC DEVICE USING THE SAME

(75) Inventors: Keitaro YAMASHITA, Chu-Nan (TW); Minoru SHIBAZAKI, Chu-Nan (TW)

(73) Assignee: CHIMEI INNOLUX CORPORATION, Chu-Nan (TW)

(21) Appl. No.: 13/191,164

(22) Filed: Jul. 26, 2011

Related U.S. Application Data
(60) Provisional application No. 61/370,278, filed on Aug. 3, 2010.

(30) Foreign Application Priority Data
Sep. 22, 2010 (JP) 2010-211867

(51) Int. Cl. G02F 1/133

(52) U.S. Cl. 349/33

(57) ABSTRACT

The invention provides a liquid crystal display device capable of ensuring high transparent aperture ratio and realizing high resolution. The liquid crystal display device comprises: a first transparent substrate (301); a second transparent substrate (301) facing the first transparent substrate; an insulating layer (304) formed on the second transparent substrate; a plurality of pixel electrodes (20) formed on the insulating layer in a matrix form; an opposite electrode (24) formed on the first transparent substrate, facing the pixel electrode, and having a predetermined potential; a liquid crystal layer (303) existing between the pixel electrode and the opposite electrode; a pixel circuit (305) formed on the upper surface of the second transparent substrate, applying a voltage on the pixel electrode; and at least one parallel electrode (307′) parallel with the pixel electrode in the insulating layer.

### CROSS REFERENCE TO RELATED APPLICATIONS

This application claims the benefit of U.S. Provisional application No. 61/370,278 filed Aug. 3, 2010, the entirety of which is incorporated by reference herein.

### BACKGROUND OF THE INVENTION

1. Field of the Invention

The present invention relates to a liquid crystal display device, and in particular relates to an electronic device using the same.

2. Description of the Related Art

In a display device having a plurality of pixels arranged in a matrix formed by rows and columns, each pixel is arranged at an intersection region of a signal line (also called a source line) and a scan line (also called a gate line). Each pixel further comprises a pixel electrode formed on a transparent substrate, and an opposite electrode formed on an opposite transparent substrate. All opposite electrodes are connected to a fixed voltage source. Because the fixed voltage source is provided to all pixels, the opposite electrode is also called a common electrode. When a pixel on a row is selected via the gate line, the pixel electrode of the pixel on the row is electrically connected to the source line and applied with a signal voltage. Thereby, a voltage difference is generated between the pixel electrode and the common electrode to drive a display element disposed therebetween. In the case where the display element is a liquid crystal, the orientation of liquid crystal molecules is varied by the voltage difference produced between the pixel electrode and the common electrode. Accordingly, for the display device, the amount of the transmissive light or reflective light is controlled so as to display an image.

Each pixel has a thin film transistor (TFT) disposed between the pixel electrode and the source line and conducted in response with a scan signal from the gate line. Even if the TFT is under a non-conductive state, a current leakage due to light illumination or temperature change may flow from the pixel electrode to the source line, causing some display problems like flicker or crosstalk.

To avoid the problems, increasing capacity of a holding capacitor which is arranged in each pixel to hold the voltage difference produced between the pixel electrode and the common electrode is a well-known method. For example, Japanese published patent no. 2008-009380 (patent document 1) discloses a method to restrain display defects, such as flicker or crosstalk, by improving fabrication processes to increase the capacity of the holding capacitor.

In order to restrain flicker and crosstalk and improve temperature properties, a larger sized holding capacitor is preferred. However, increasing the size of the holding capacitor will reduce the transparent aperture of the pixel. To avoid the reduction of the transparent aperture, resolution or PPI (pixel number per inch) may be decreased.

To solve the above problems, the present invention provides a liquid crystal display device and an electronic device using the same capable of assuring high transparent aperture and realizing high resolution.

### BRIEF SUMMARY OF THE INVENTION

A detailed description is given in the following embodiments with reference to the accompanying drawings.

To achieve the above purpose, the present invention provides a liquid crystal display device including: a first transparent substrate; a second transparent substrate facing the first transparent substrate; an insulating layer formed on the second transparent substrate; a plurality of pixel electrodes arranged in a matrix on the insulating layer; an opposite electrode formed on the first transparent substrate, located opposite to the pixel electrodes and having a predetermined voltage level; a liquid crystal layer located between the pixel electrodes and the opposite electrode; a pixel circuit formed on the upper surface of the second transparent substrate, applying a voltage to one of the pixel electrodes; and at least one parallel electrode parallel to the pixel electrodes in the insulating layer.

Using the above structure, the liquid crystal display device can assure high transparent aperture and realize high resolution.

In an embodiment, the liquid crystal display device further includes a pair of parallel electrodes parallel to the pixel electrodes in the insulating layer, wherein the pair of parallel electrodes form a capacitor to hold a voltage difference between one of the pixel electrodes and the opposite electrode.

In an embodiment, the at least one parallel electrode and one of the pixel electrodes form a capacitor to hold a voltage difference between the pixel electrode and the opposite electrode. The at least one parallel electrode can extend across the plurality of pixel electrodes in the insulating layer. The at least one parallel electrode has a voltage level equal to the voltage level of the opposite electrode. The at least one parallel electrode is constituted by transparent electrode materials.

In an embodiment, the pixel circuit comprises at least one of a memory, a sensor, a conductive wire, a conductive via, and a signal processor. The memory comprises a DRAM or a SRAM.

In an embodiment, the liquid crystal display device is a reflective type liquid crystal display device, further including a reflector formed on a part or all of each pixel electrode. In the embodiment, the liquid crystal layer can respond to the voltage difference between each pixel electrode and the opposite electrode to control the amount of external light reflected by the reflector.

In an embodiment, the liquid crystal display device is a transmissive type liquid crystal display device, further including a backlight source, radiating light from the lower surface of the second transparent substrate to the upper surface. In the embodiment, the liquid crystal layer can respond to the voltage difference between each pixel electrode and the opposite electrode to control the amount of backlight passing therethrough.

In an embodiment, the liquid crystal display device is a transflective type liquid crystal display device, further including: a backlight source, radiating light from the lower surface of the second transparent substrate to the upper surface; and a reflector formed on a part of each pixel electrode to cover the pixel circuit. In the embodiment, the liquid crystal layer can respond to the voltage difference between each pixel electrode and the opposite electrode to control the amount of backlight passing therethrough and the amount of external light reflected by the reflector.

In an embodiment, the liquid crystal display device of the invention can be applied to electronic devices with display panels for providing users with images, such as a television, a laptop or desktop computer, a cell phone, a digital camera, a PDA, a car navigation device, a portable game device, an AURORA VISION, or etc.

According to the embodiments of the invention, a liquid crystal display device and an electronic device using the same capable of assuring high transparent aperture and realizing high resolution are provided.

### BRIEF DESCRIPTION OF THE DRAWINGS

The present invention can be more fully understood by reading the subsequent detailed description and examples with references made to the accompanying drawings, wherein:

FIG. 1 is a schematic view of a liquid crystal display device in accordance with an embodiment of the invention

FIG. 2 is a circuitry diagram of a pixel in the liquid crystal display device in accordance with an embodiment of the invention.

FIG. 3 is an example of a conventional pixel structure, wherein the circuit of the pixel is shown in FIG. 2.

FIG. 4 shows a pixel structure in accordance with a first embodiment of the invention, wherein the circuit of the pixel is shown in FIG. 2.

FIG. 5 shows a pixel structure in accordance with a second embodiment of the invention.

FIG. 6 shows a pixel structure in accordance with a third embodiment of the invention.

FIG. 7 shows a circuit diagram of a pixel structure comprising a MIP circuit constituted by a DRAM.

FIG. 8 is a timing chart for describing an example of the operation of the pixel circuit shown in FIG. 7.

FIG. 9 is a diagram showing the relationship between transparent aperture and PPI, of the pixel structure having the MIP circuit shown in FIG. 7 in the cases where the invention is applied and not applied to the pixel structure.

FIG. 10 is an example showing an electronic device provided with the liquid crystal display device in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

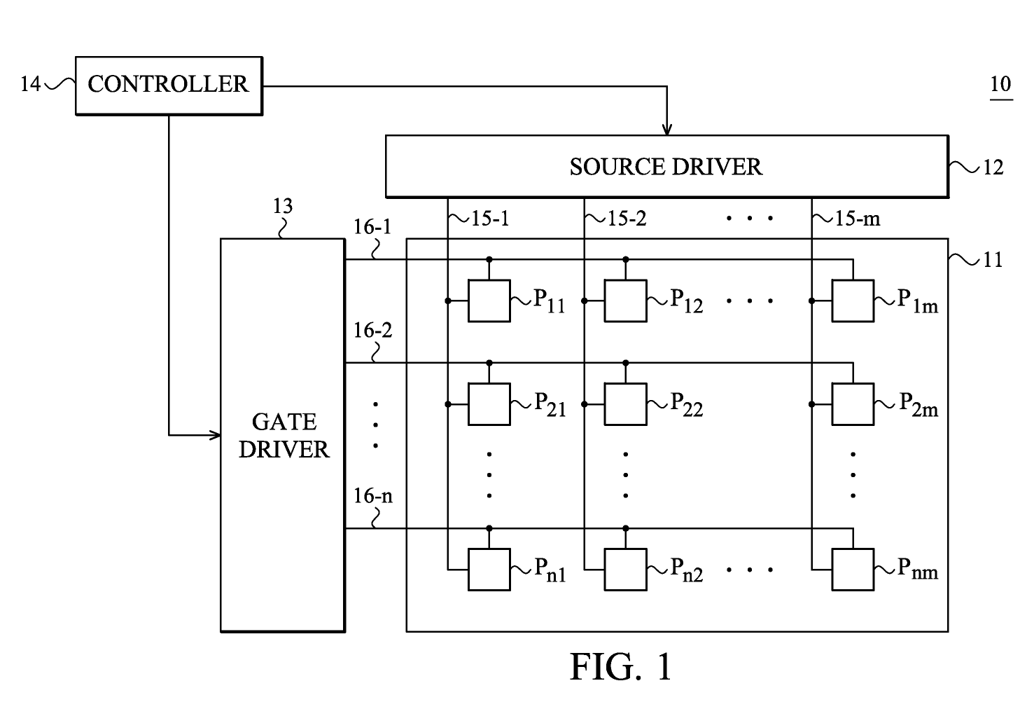

FIG. 1 is a schematic view of a liquid crystal display device in accordance with an embodiment of the invention. In FIG. 1, a display device 10 comprises a display panel 11, a source driver 12, a gate driver 13, and a controller 14.

The display panel 11 comprises a plurality of pixels P₁₁˜Pₙₘ (m and n are integers) arranged in a matrix formed by rows and columns. The display panel 11 further comprises a plurality of source lines 15-1˜15-m arranged corresponding to the columns, and a plurality of gate lines 16-1˜16-n arranged corresponding to the rows and orthogonal to the source lines 15-1˜15-m.

The source driver 12 is a signal line driving circuit for driving the source lines 15-1˜15-m according to the image data. The source driver 12 applies signal voltages to the pixels P₁₁˜Pₙₘ via the source lines 15-1˜15-m. The gate driver 13 is a scan line driving circuit for driving the gate lines 16-1˜16-n in sequence. The gate driver 13 controls signal voltage applying timings of the pixels P₁₁˜Pₙₘ via the gate lines 16˜16-n. Specifically, the gate driver 13 drives pixels on a row with an interlaced scan or progressive scan procedure so that the pixels on that row are applied with signal voltages through the source lines. For example, in the liquid crystal display device, by applying of the signal voltages, the orientation of the liquid crystal molecules is varied so as to polarize back light or external light (reflected light) to display images.

The controller 14 synchronizes the source driver 12 and the gate driver 13, and controls the above devices.

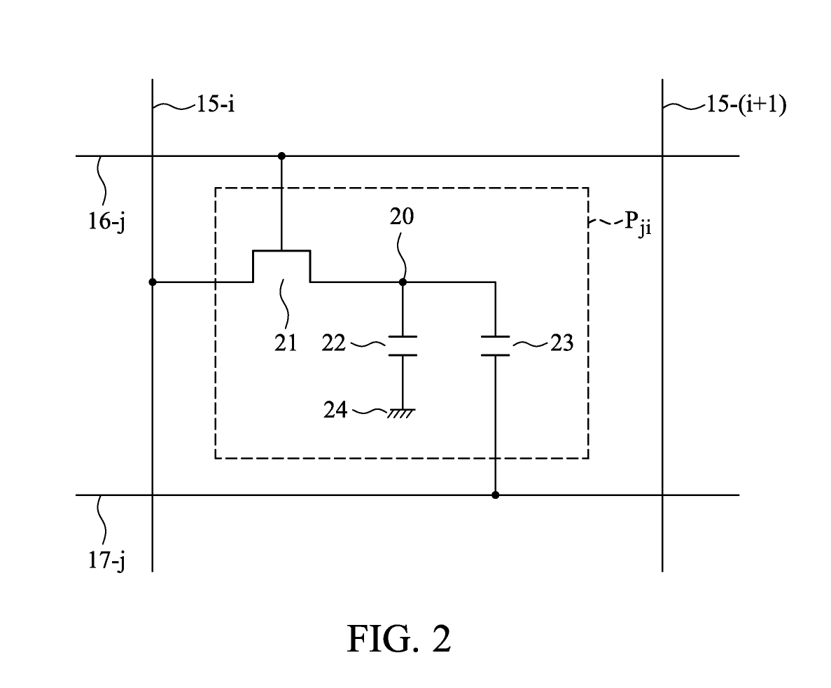

FIG. 2 is a circuitry diagram of a pixel in the liquid crystal display device in accordance with an embodiment of the invention.

The pixel Pⱼᵢ (i and j are integers, wherein 1≦i≦m and 1≦j≦n) is arranged at the cross region of the i-th source line 15-i and the j-th gate line 16-j. Further, a CS line 17-j which is parallel to the gate line 16-j is disposed on the pixel row.

The pixel Pⱼᵢ comprises a pixel electrode 20, a switch element 21, a liquid crystal display element 22, a holding capacitor 23, and a common electrode 24. Briefly, the liquid crystal display element 22 disposed between the pixel electrode 20 and the common electrode 24 in FIG. 2 is represented by a capacitor. The common electrode 24 connects all pixels P₁₁˜Pₙₘ to a fixed voltage source to provide a predetermined potential to all pixels P₁₁˜Pₙₘ.

The switch element 21 is disposed between the pixel electrode 20 and the source line 15-i, wherein the control terminal of the switch element 21 is connected to the gate line 16-j. The switch element 21 responds to a scan signal transmitted by the gate line 16-j and is conducted, so that the pixel electrode 20 is electrically connected to the source line 15-i. Therefore, the signal voltage transmitted by the source line 15-i is applied to the pixel electrode 20. In general, a thin film transistor (TFT) is used as the switch element 21. In FIG. 2, the switch element 21 is represented by an N type TFT, which is conducted when the scan signal is at a high level.

The holding capacitor 23 is disposed between the pixel electrode 20 and the CS line 17-j and holds a voltage difference between the pixel electrode 20 and the common electrode 24 during the period from the beginning of the non-conductive state (OFF state) of the switch element 21 through the beginning of the next conductive state (ON state) of the switch element 21. In some cases, the holding capacitor 23 is connected to the common electrode 24 rather than the CS line 17-j.

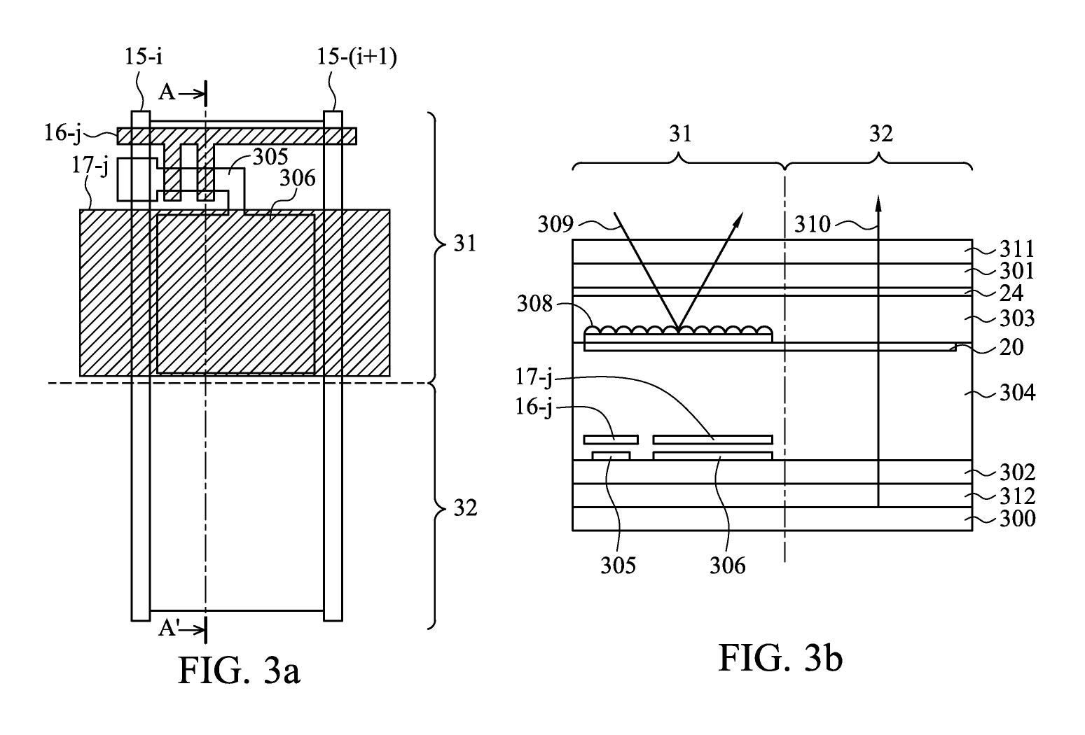

FIG. 3 is an example of a conventional pixel structure, wherein the circuit of the pixel is shown in FIG. 2.

FIG. 3a is a top view of the pixel. The source line 15-i and the adjacent source line 15-(i+1) extend along the vertical direction. The gate line 16-j extends along the horizontal direction and intersects with the source lines. The shadow parts in FIG. 3a represent the gate line 16-j and the CS line 17-j. Under the gate line 16-j and the Cs line 17-j, a conductive path 305 of the switch element 21 and a capacitor electrode 306 are disposed. The conductive path 305 and the gate electrode extend from the gate line 16-j to the pixel region form the switch element 21. The capacitor electrode 306 and the CS line 17-j are used as a pair of parallel electrodes of the holding capacitor 23. For the pixel, a part 31 having a pixel circuit comprising the switch element 21 and the holding capacitor 23 is impenetrable for light illuminated from a back light source arranged at the back surface of the display device. Therefore, the part 31 is disposed with a reflector to reflect the external light and is used as a reflective type display region. The remaining part 32 of the pixel does not have pixel circuits and is used as a transmissive type display region which is penetrable for light illuminated from the back light source. A liquid crystal display device provided with the reflective type display region and the transmissive type display region together in such a manner is called a transflective liquid crystal display device, wherein transmissive light of the back light source is mainly utilized under a dark environment and reflective light from the external environment is mainly utilized under a bright environment. Therefore, visual identifiability is assured and power consumption is constrained.

FIG. 3b is a line A-A′ cross section of the pixel shown in FIG. 3a. The pixel comprises a first transparent substrate 301, a second transparent substrate 302 of which the upper surface faces the bottom surface of the first transparent substrate 301, a liquid crystal layer 303 formed by sealing the liquid crystal between the first transparent substrate 301 and the second transparent substrate 302, and an insulating layer 304 formed on the second transparent substrate 302. The upper surface of the first transparent substrate 301 and the bottom surface of the second transparent substrate 302 are disposed with polarizers 311 and 312, respectively, to polarize the transmissive light.

The pixel electrode 20 is formed on the insulating layer 304. The common electrode 24 is disposed on the bottom surface of the first transparent substrate 301, facing the pixel electrode 20 via the liquid crystal layer 303. The pixel electrode 20 and the common electrode 24 are formed by light-penetrable transparent electrodes, such as Indium Tin Oxide (ITO).

The upper surface of the second transparent substrate 302 is disposed with the conductive path 305 (TFT channel) of the switch element 21 and the capacitor electrode 306. The TFT channel 305 and the capacitor electrode 306 are formed by poly-silicon, for example. The gate electrode 16-j extends above the TFT channel 305, wherein the gate electrode 16-j and the TFT channel 305 form the switch element 21. The CS line 17-j extends parallel to the capacitor electrode 306 with a predetermined distance therebetween, wherein the CS line 17-j and the capacitor electrode 306 form the holding capacitor 23.

The gate electrode 16-j and the CS line 17-j are formed by light-penetrable materials such as metal materials. Therefore, the region formed with the switch element 21 and the holding capacitor 23 is disposed with a reflector 308 to reflect external light for displaying images. This region is used as a reflective type display region 31. The reflector 308 is disposed on the pixel electrode 20 and located above the switch element 21 and the holding capacitor 23. As shown by the arrow 309, the reflector 308 reflects the external light incident to the pixel.

The region which is not formed with the switch element 21 and the holding capacitor 23 allow the light illuminated from the back light source 300 to pass therethrough for displaying images. This region is used as a transmissive type display region 32.

In the pixel structure shown in FIG. 3, to increase the size of the holding capacitor 23, the area of the reflective type display region 31 will also increase. However, the area of the transmissive type display region 32 will decrease. That is to say, the transparent aperture is reduced. To maintain the transparent aperture, resolution will degrade.

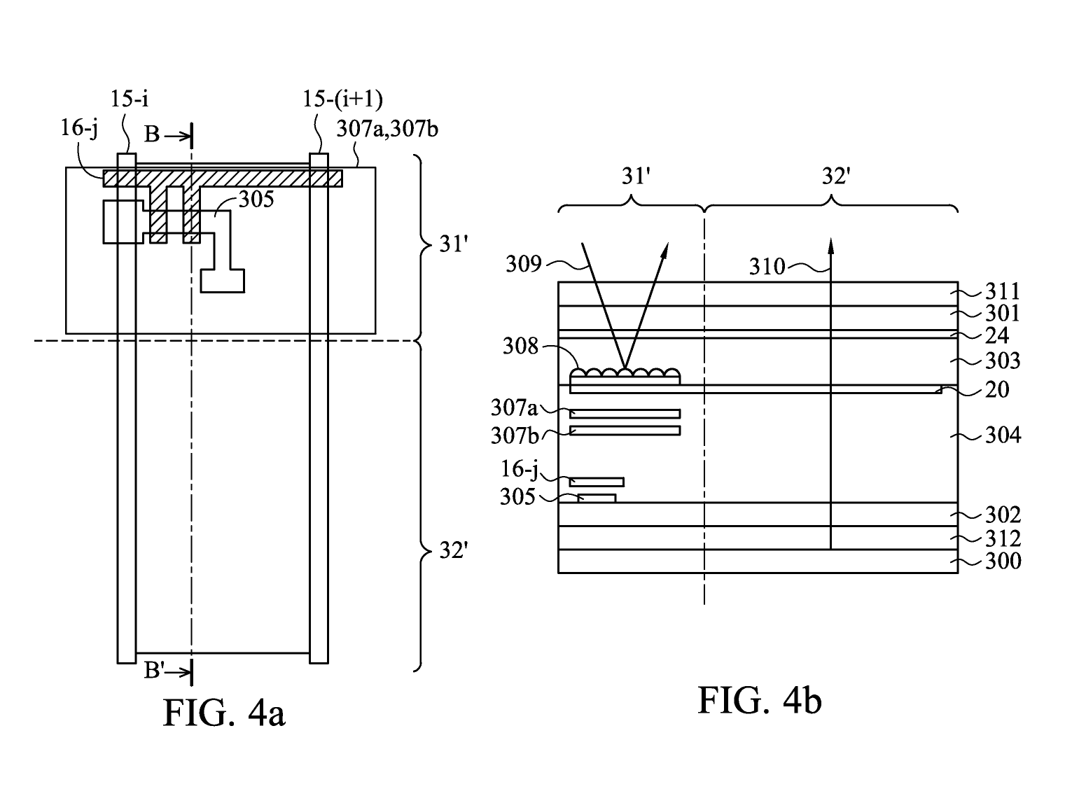

FIG. 4 shows a pixel structure in accordance with a first embodiment of the invention, wherein the circuit of the pixel is shown in FIG. 2.

FIG. 4a is a top view of the pixel. The source line 15-i and the adjacent source line 15-(i+1) extend along the vertical direction. The gate line 16-j extends along the horizontal direction and intersects with the source lines. The shadow parts in FIG. 4a represent the gate line 16-j. Under the gate line 16-j, a conductive path 305 of the switch element 21 is disposed. The conductive path 305 and the gate electrode extending from the gate line 16-j to the pixel region form the switch element 21. Above the gate line 16-j, a pair of parallel electrodes of the holding capacitor 23, namely, capacitor electrodes 307a and 307b, are formed. For the pixel, a part 31′ having a pixel circuit comprising the switch element 21 and the holding capacitor 23 is impenetrable for light illuminated from a back light source arranged at the back surface of the display device. Therefore, the part 31′ is disposed with a reflector to reflect the external light and is used as a reflective type display region. The remaining part 32′ of the pixel does not have pixel circuits and is used as a transmissive type display region which is penetrable for light illuminated from the back light source.

FIG. 4b is a line B-B′ cross section of the pixel shown in FIG. 4a. The pixel comprises a first transparent substrate 301, a second transparent substrate 302 of which the upper surface faces the bottom surface of the first transparent substrate 301, a liquid crystal layer 303 formed by sealing the liquid crystal between the first transparent substrate 301 and the second transparent substrate 302, and an insulating layer 304 formed on the second transparent substrate 302. The upper surface of the first transparent substrate 301 and the bottom surface of the second transparent substrate 302 are disposed with polarizers 311 and 312, respectively, to polarize the transmissive light.

The pixel electrode 20 is formed on the insulating layer 304. The common electrode 24 is disposed on the bottom surface of the first transparent substrate 301, facing the pixel electrode 20 via the liquid crystal layer 303. The pixel electrode 20 and the common electrode 24 are formed by light-penetrable transparent electrodes, such as Indium Tin Oxide (ITO).

The upper surface of the second transparent substrate 302 is disposed with the conductive path 305 (TFT channel) of the switch element 21. The gate electrode 16-j extends above the TFT channel 305, wherein the gate electrode 16-j and the TFT channel 305 form the switch element 21.

Two capacitor electrodes extend parallel to each other with a predetermined distance therebetween. Two capacitor electrodes are located right under the pixel electrode 20 and right above the switch element 21. Therefore, the capacitor electrodes 307a and 307b form the holding capacitor 23, wherein one of the capacitor electrodes 307a and 307b is the CS line 17-j shown in FIG. 2.

In the embodiment, the gate electrode 16-j and the capacitor electrodes 307a and 307b are formed by light-penetrable materials such as metal materials. Therefore, the region formed with the switch element 21 and the holding capacitor 23 is disposed with a reflector 308 to reflect external light for displaying images. This region is used as a reflective type display region 31′. The reflector 308 is disposed on the pixel electrode 20 and located above the switch element 21 and the holding capacitor 23. As shown by the arrow 309, the reflector 308 reflects the external light incident to the pixel.

The region which is not formed with the switch element 21 and the holding capacitor 23 allow the light illuminated from the back light source 300 to pass therethrough for displaying images. This region is used as a transmissive type display region 32′.

In the pixel structure shown in FIG. 4, the thickness direction of the display panel is utilized to dispose the holding capacitor 23. In comparison with the pixel structure shown in FIG. 3, the area of the reflective type display region 31′ is decreased. However, the area of the transmissive type display region 32′ is increased. That is to say, the transparent aperture is increased, so that resolution could be upgraded.

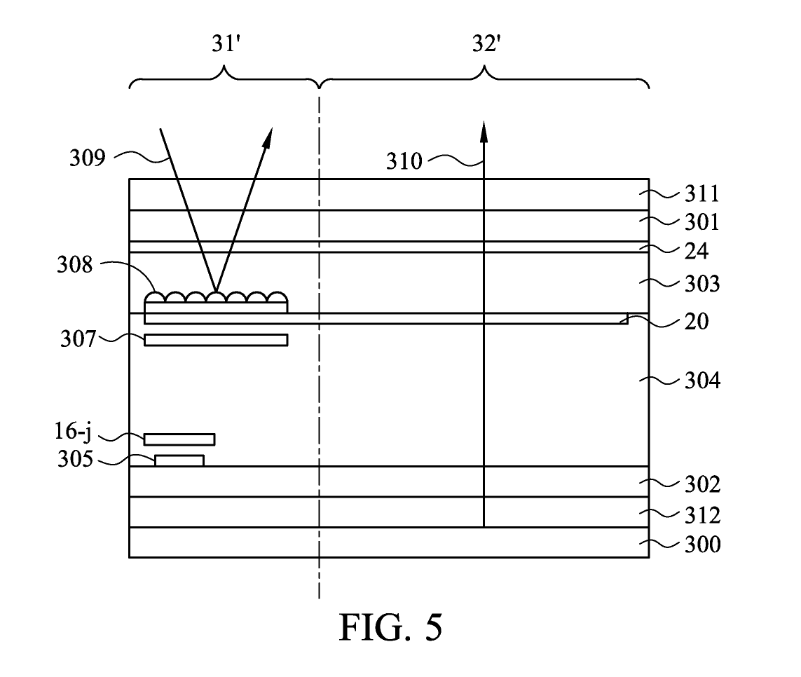

FIG. 5 shows a pixel structure in accordance with a second embodiment of the invention. In the pixel structure shown in FIG. 5, only one capacitor electrode 307 is disposed. The capacitor electrode 307 is disposed under the pixel electrode 20 with a predetermined distance, wherein the capacitor electrode 307 and the pixel electrode form the holding capacitor 23. The capacitor electrode 307 may be the CS line 17-j shown in FIG. 2.

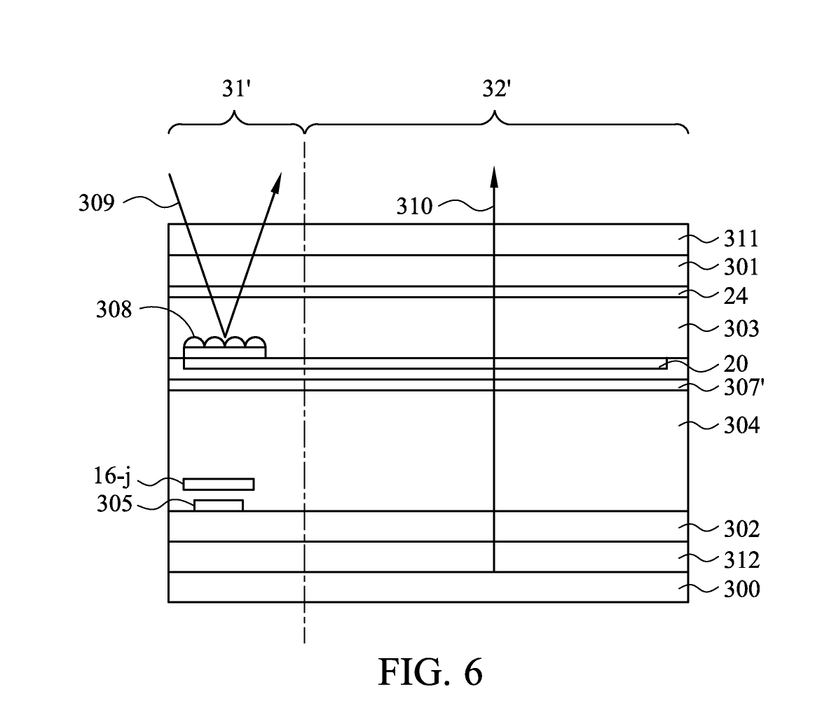

FIG. 6 shows a pixel structure in accordance with a third embodiment of the invention. In the pixel structure shown in FIG. 6, a capacitor electrode 307′ is not only located within the reflective type display region 31′ but also extends to the transmissive type display region 32′. Note that, the capacitor electrode 307′ must be a light-penetrable transparent electrode. For example, the transparent electrode could be formed by an ITO.

In the embodiment shown in FIG. 6, though the capacitor electrode 307′ extends to the outside region of the pixel electrode 20, the capacitor electrode 307′ may be located just under the pixel electrode 20, practically. For a vertical alignment liquid crystal device, the capacitor electrode 307′ extends across all pixel electrodes 20 arranged on the display panel, namely, across the entire pixel display region of the second transparent substrate 302, thereby handling the domain issue for the vertical alignment liquid crystal device. Here, a domain issue means that when a user uses a finger to press a display panel under a white display state, the region bearing the pressure will display non-uniformly. This results from the structure of the vertical alignment liquid crystal device. Specifically, because electric fields between adjacent pixel electrodes do not have a definite boundary, the electric fields are successive and influence each other.

For example, Japanese patent no. 4410276 discloses a method to solve the domain issue of the vertical alignment liquid crystal device. In the specification of Japanese patent no. 4410276, the method to solve the domain issue disposes a lower electrode under the pixel electrode, wherein an insulating layer is located therebetween, and provides a potential equal to the potential of the common electrode to the lower electrode. Therefore, a boundary of electric fields is produced between adjacent pixel electrodes. A physical gap exists between adjacent pixel electrodes and an equipotential plane is formed between the common electrode and the lower electrode. Electric fields located between a pixel electrode and the common electrode do not extend across the equipotential plane around the pixel electrode to the outside. Thus, the effect of the equipotential plane is equal to a boundary of the electric fields located between adjacent pixel electrodes.

In the embodiment of the invention, the capacitor electrode 307′ extends across the entire pixel display region, comprising the downside of the pixel electrode 20, of the second transparent substrate 302, thereby realizing the function of the lower electrode disclosed in Japanese patent no. 4410276. In this case, the transparent electrode 307′ should have a potential equal to the potential of the common electrode.

So far, a transflective type liquid crystal display device is taken as an example, but the embodiments of the invention can be applied to any one of the reflective type liquid crystal display device and the transmissive type liquid crystal display device. Whichever liquid crystal display device the embodiment of the invention is applied to, high transparent aperture is assured and high resolution is realized.

By using the embodiments of the invention, an additional circuit comprising a memory, a sensor, conductive wires, conductive vias, and/or a signal processor can be incorporated in a pixel without loss of transparent aperture and resolution. The case where a MIP (Memory in Pixel) circuit is incorporated in a pixel is taken as an example to describe the above situation.

The MIP technique means that a memory is arranged to a pixel, and when a static image is displayed, data stored in the memory is written into the pixel so that a driver may stop driving the pixel to reduce power consumption. The MIP technique is suitable for the reflective type liquid crystal display used in a low-power-consumption portable device which does not use a back light source and is often driven by a battery. For example, most of the time a cell phone is used under a standby state, wherein a large part of or the entire display panel displays a static image in general. Therefore, the MIP technique can be used to constrain power consumption of the battery of the cell phone.

Generally, in the MIP technique, a memory circuit for storing data is adopted with a DRAM (Dynamic Random Access Memory) or SRAM (Static Random Access Memory). The SRAM is constituted by a transistor sequential circuit. On the other hand, the DRAM is constituted by a transistor and a capacitor. Therefore, in view of minification of the circuit area and narrowness of the pixel gap, the DRAM is preferred. However, a DRAM needs a refresh operation to hold tiny electric charges stored in the capacitor.

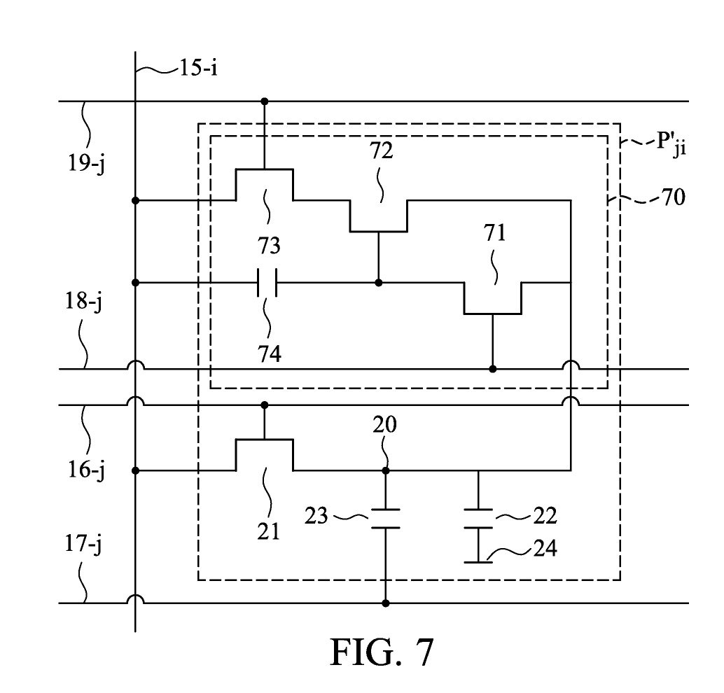

FIG. 7 shows a circuit diagram of a pixel structure comprising a MIP circuit constituted by a DRAM.

In addition to a pixel electrode 20, a switch element 21, a liquid crystal display element 22, a holding capacitor 23, and a common electrode 24, a pixel P′ⱼᵢ further comprises a memory circuit 70. The memory circuit 70 comprises second, third, and fourth switch elements 71˜73, and a sampling capacitor 74. The second, third, and fourth switch elements 71˜73 can be TFTs. A terminal of the sampling capacitor 74 is connected to the source line 15-i and the other terminal of the sampling capacitor 74 is connected to the pixel electrode 20 via the second switch element 71.

Furthermore, a sampling line 18-j and a refresh line 19-j traverse the P′ⱼᵢ. A sampling line and a refresh line are disposed for a pixel row or column. In the embodiment, because pixels are selected with a unit of a row, the sampling line and the refresh line are disposed for each pixel row.

The control terminal of the second switch element 71 is connected to the sampling line 18-j. The third switch element 72 and the fourth switch element 73 is connected in series between the pixel electrode 20 and the source line 15-i. The control terminal of the third switch element 72 is connected to a point between the sampling capacitor 74 and the second switch element 71. The control terminal of the fourth switch element 73 is connected to the refresh line 19-j. The sampling capacitor 74, the second, and the third switch elements 71, and 72 form a DRAM.

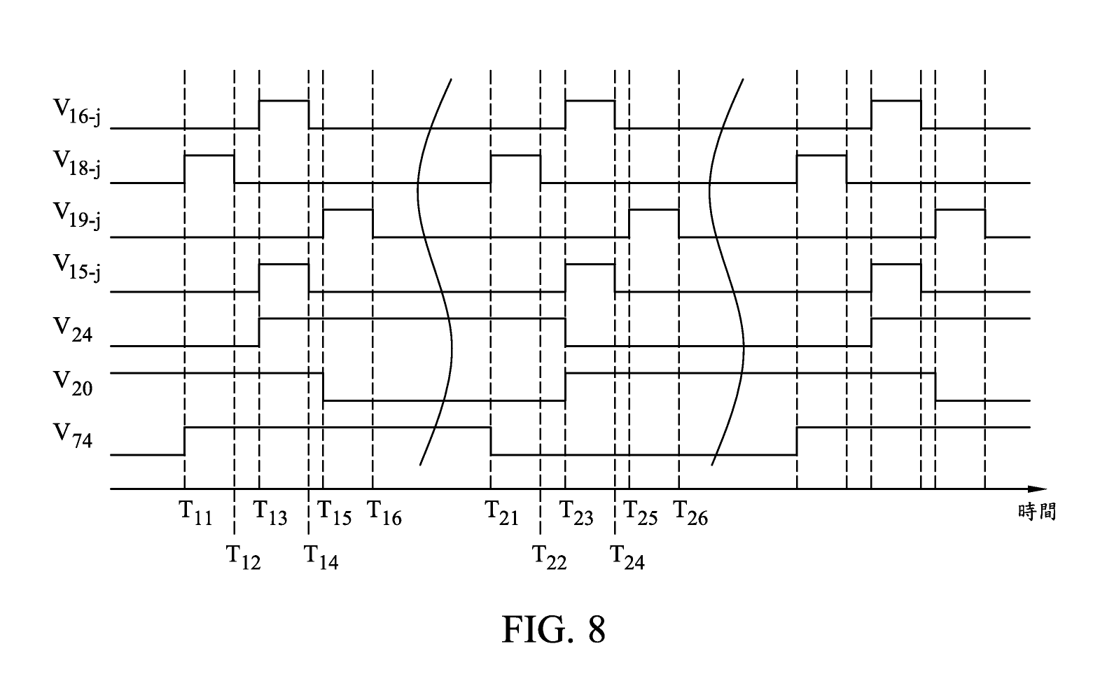

Following, assuming that a liquid crystal display device in accordance with the embodiment of the invention comprises the pixel circuit shown in FIG. 7, the liquid crystal display device is a normally black type vertical alignment liquid crystal display device which displays a black image when no voltages are applied to the pixel electrodes and the liquid crystal molecules are vertically aligned. A reverse driving operation under a white displaying state is described as follows. FIG. 8 is a timing chart for describing an example of the operation of the pixel circuit shown in FIG. 7.

Under an initial state (˜T₁₁), the voltage level (called “pixel voltage” in the following) V₂₀ of the pixel electrode 20 is high (for example, 5V), and the voltage level (called “common voltage” in the following) V₂₄ of the common electrode 24 (and the CS line 17-j) is low (for example, 0V). Meanwhile, the first, second, third, and fourth switch elements 21, 71˜73 are turned off

At timing T₁₁, to sample the present pixel voltage V₂₀, the voltage level V₁₈₋ⱼ is raised to high by the controller 14 and the second switch element 71 is turned on. Therefore, the voltage level (called “sampling voltage” in the following) V₇₄ between the second switch element 71 and the sampling capacitor 74 becomes a voltage level equivalent to high. Although the voltage level V₁₈₋ⱼ on the sampling line is pulled down to low later at the timing T₁₂, the sampling voltage V₇₄ still maintains at high because of the effect of the capacitor 74.

During the period T₁₃˜T₁₄, to precharge the display element 22 and the holding capacitor 23, the voltage level V₁₆₋ⱼ on the gate line is raised to high by the gate driver 13. Meanwhile, the voltage level V₁₅₋ᵢ on the source line is raised to high by the source driver 12. Thus, the first switch element 21 is turned on and the pixel electrode 20 is connected to the source line 15-i. At the beginning T₁₃ of the precharge period, the common voltage V₂₄ is raised to high.

At the end T₁₄ of the precharge period, the voltage level V₁₆₋ⱼ on the gate line is pulled down to low by the gate driver 13 and the first switch element 21 is turned off. Following, the voltage level V₁₅₋ᵢ on the source line is pulled down to low by the source driver 12 and the common voltage V₂₄ maintains at high.

Next, at timing T₁₅, the voltage level V₁₉₋ⱼ on the refresh line is raised to high by the controller 14 and the fourth switch element 73 is turned on. Because the conductive terminal (source) of the third switch element 72 is connected to the source line 15-i via the fourth switch element 73, the voltage level at the conductive terminal of the third switch element 72 becomes low. At this time, the sampling voltage V₇₄ at the control terminal of the third switch element 72 is high so the third switch element 72 is turned on. Accordingly, the pixel electrode 20 is connected to the source line 15-i via the third switch element 72 and the fourth switch element 73, and the pixel voltage V₂₀ is low. At timing T₁₆, the voltage level V₁₉₋ⱼ, on the refresh line is pulled down to low again and the fourth switch element 73 is turned off

Finally, the pixel voltage V₂₀ and the common voltage V₂₄ are reversed with respect to the initial states, namely, a high voltage level is exchanged to a low voltage level, and vice versa. Therefore, the voltage difference between two ends of the display element 22 is −5V, wherein the polarity has been reversed.

Under this state, at the next sampling timing T₂₁, to sample the present pixel voltage V₂₀, the voltage level V₁₈₋ⱼ is raised to high by the controller 14 and the second switch element 71 is turned on. Therefore, the sampling voltage V₇₄ becomes a voltage level equivalent to low. After that the voltage level V₁₈₋ⱼ on the sampling line is pulled down to low later.

During the period T₂₃˜T₂₄, to precharge the display element 22 and the holding capacitor 23, the voltage level V₁₆₋ⱼ on the gate line is raised to high by the gate driver 13. Meanwhile, the voltage level V₁₅₋ᵢ on the source line is raised to high by the source driver 12. Thereby, the first switch element 21 is turned on and the pixel electrode 20 is connected to the source line 15-i. At the beginning T₂₃ of the precharge period, the common voltage V₂₄ is raised to high.

At the end T₂₄ of the precharge period, the voltage level V₁₆₋ⱼ on the gate line is pulled down to low by the gate driver 13 and the first switch element 21 is turned off. Following, the voltage level V₁₅₋ᵢ on the source line is pulled down to low by the source driver 12.

Next, at timing T₂₅, the voltage level V₁₉₋ⱼ on the refresh line is raised to high by the controller 14 and the fourth switch element 73 is turned on. Because the conductive terminal (source) of the third switch element 72 is connected to the source line 15-i via the fourth switch element 73, the voltage level at the conductive terminal of the third switch element 72 becomes low. At this time, the sampling voltage V₇₄ at the control terminal of the third switch element 72 is low so the third switch element 72 is still turned off. Because the third switch element 72 is turned off, the pixel electrode 20 is not connected to the source line 15-i, and the pixel voltage V₂₀ maintains at high. At timing T₂₆, the voltage level V₁₉₋ⱼ on the refresh line is pulled down to low again and the fourth switch element 73 is turned off

Finally, the pixel voltage V₂₀ and the common voltage V₂₄ are reversed again, wherein a high voltage level is exchanged to a low voltage level, and vice versa. The pixel voltage V₂₀ and the common voltage V₂₄ go back to the initial states. Therefore, the voltage difference between two ends of the display element 22 is +5V, wherein the polarity has been reversed again.

In comparison with the pixel circuit shown in FIG. 2, the pixel circuit with the MIP circuit shown in FIG. 7 occupies a larger space. To obtain the maximum transparent aperture, the MIP circuit is usually formed within a region of the transparent substrate which is right under the reflector (for example, the second transparent substrate 302 in FIG. 3). Refer to FIG. 3, in the conventional pixel structure, to install the MIP circuit in the pixel and maintain a measure of transparent aperture, the space for forming the holding capacitor 23 on the second transparent substrate 302 is limited. However, the holding capacitor 23 cannot be minimized, or the problem such as flicker and crosstalk will occur. Therefore, the transparent aperture must be reduced. To maintain at high transparent aperture, the resolution of the liquid crystal display device will decrease. The invention is suitable for the case where an additional circuit such as the MIP circuit is incorporated in the pixel. According to the embodiments of the invention shown in FIGS. 4˜6, The MIP circuit can be formed on a region of the second transparent substrate 302, wherein the region is used for forming the holding capacitor in the conventional method, so that the memory function may be introduced without loss of transparent aperture and resolution.

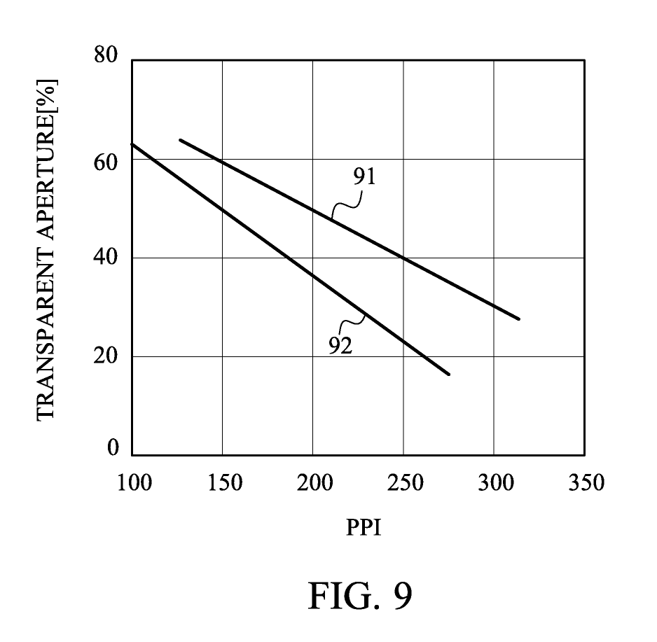

FIG. 9 is a diagram showing the relationship between transparent aperture and PPI, of the pixel structure having the MIP circuit shown in FIG. 7 in the cases where the invention is applied and not applied to the pixel structure. In FIG. 9, the vertical axis represents transparent aperture (unit: %) and the horizontal axis represents PPI. Here, transparent aperture means the ratio of the area of the transmissive type display region to the area of the entire pixel, wherein the pixel is provided with the transmissive type display region and the reflective type display region.

The first line 91 shows the relationship between transparent aperture and PPI in the case where the invention is applied to the pixel structure; namely, in the case where the space of thickness direction is utilized for forming the holding capacitor, as shown in FIGS. 4˜6. The second line 92 shows the relationship between transparent aperture and PPI in the case where the invention is not applied to the pixel structure; namely, in the case where the holding capacitor is formed on the lower transparent substrate, as shown in FIG. 3.

From FIG. 9, in whichever case, the higher the transparent aperture is the lower the PPI is. When the invention is applied the pixel structure, a higher transparent aperture can be obtained under the same PPI or a higher PPI can be obtained under the same transparent aperture. Therefore, according to the invention, high transparent aperture can be assured and high resolution can be realized.

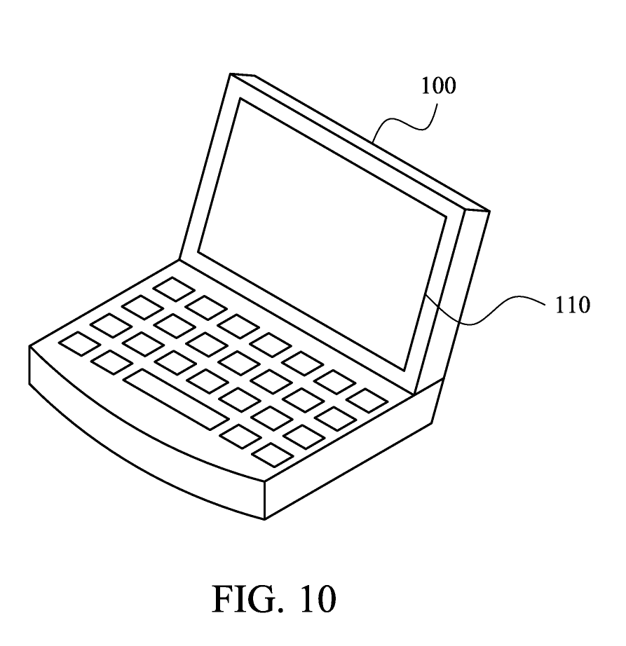

FIG. 10 is an example showing an electronic device provided with the liquid crystal display device in accordance with an embodiment of the invention. The electronic device 100 in FIG. 10 is represented by a notebook, but other electronic devices such as a television, a desktop computer, a cell phone, a digital camera, a PDA, a car navigation device, a portable game device, an AURORA VISION, or etc. is also suitable for the invention.

The notebook 100 is provided with a display device 110, and the display device 110 has a display panel to show information in the form of images. The display panel of the display device 110 is provided with a matrix arrangement for pixels having the structure shown in FIGS. 4-6. The display device 110 can also have a touch panel function. In this case, a sensor circuit for detecting a touch will be incorporated in each pixel. Specifically, the sensor circuit is formed on the region of the lower transparent substrate (for example, the second transparent substrate 302) overlapped with the reflector.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display device, comprising
a first transparent substrate;
a second transparent substrate facing the first transparent substrate;
an insulating layer formed on the second transparent substrate;
a plurality of pixel electrodes arranged in a matrix on the insulating layer;
an opposite electrode formed on the first transparent substrate, located opposite to the pixel electrodes and having a predetermined voltage level;
a liquid crystal layer located between the pixel electrodes and the opposite electrode;
a pixel circuit formed on the upper surface of the second transparent substrate, applying a voltage to one of the pixel electrodes; and
at least one parallel electrode parallel to the pixel electrodes in the insulating layer.

2. The liquid crystal display device as claimed in claim 1, further comprising:
a pair of parallel electrodes parallel to the pixel electrodes in the insulating layer, wherein the pair of parallel electrodes form a capacitor to hold a voltage difference between one of the pixel electrodes and the opposite electrode.

3. The liquid crystal display device as claimed in claim 1, wherein the at least one parallel electrode and one of the pixel electrodes form a capacitor to hold a voltage difference between the pixel electrode and the opposite electrode.

4. The liquid crystal display device as claimed in claim 3, wherein the at least one parallel electrode extends across the plurality of pixel electrodes in the insulating layer.

5. The liquid crystal display device as claimed in claim 4, wherein the at least one parallel electrode has a voltage level equal to the voltage level of the opposite electrode.

6. The liquid crystal display device as claimed in claim 3, wherein the at least one parallel electrode is constituted by transparent electrode materials.

7. The liquid crystal display device as claimed in claim 1, wherein the pixel circuit comprises at least one of a memory, a sensor, a conductive wire, a conductive via, and a signal processor.

8. The liquid crystal display device as claimed in claim 7, wherein the memory comprises a DRAM or a SRAM.

9. The liquid crystal display device as claimed in claim 1, further comprising:
a reflector formed on a part or all of each pixel electrode,
wherein the liquid crystal layer responds to the voltage difference between each pixel electrode and the opposite electrode to control the amount of external light reflected by the reflector.

10. The liquid crystal display device as claimed in claim 1, further comprising:
a backlight source, radiating light from the lower surface of the second transparent substrate to the upper surface,
wherein the liquid crystal layer responds to the voltage difference between each pixel electrode and the opposite electrode to control the amount of backlight passing therethrough.

11. The liquid crystal display device as claimed in claim 1, further comprising:
a backlight source, radiating light from the lower surface of the second transparent substrate to the upper surface; and
a reflector formed on a part of each pixel electrode to cover the pixel circuit,
wherein the liquid crystal layer responds to the voltage difference between each pixel electrode and the opposite electrode to control the amount of backlight passing therethrough and the amount of external light reflected by the reflector.

12. An electronic device comprising the liquid crystal display device as claimed in claim 1.
